(19) United States
(12) Patent Application Publication
(10) Pub. No.: US 2012/0254516 A1
(43) Pub. Date: Oct. 4, 2012

(54) CONTROL DEVICE, STORAGE DEVICE, AND READING CONTROL METHOD

(75) Inventor: Shingo Aso, Tokyo (JP)

(73) Assignee: SONY CORPORATION, Tokyo (JP)

(21) Appl. No.: 13/414,395

(22) Filed: Mar. 7, 2012

(30) Foreign Application Priority Data
Mar. 29, 2011 (JP) 2011-071420

(51) Int. Cl. G06F 12/00

(52) U.S. Cl. 711/103; 711/E12.008

(57) ABSTRACT

A control device includes an administration unit that administrates logical pages of respective logical blocks so that confirmation reading target pages are arranged in a manner to be dispersed in physical pages of first to nth non-volatile memories among a plurality of logical blocks, in a case where logical blocks including physical blocks of the first to nth non-volatile memories are formed, with respect to a storage device in which concurrent reading access can be performed to the first to nth non-volatile memories serving as non-volatile memories in which a physical block is composed of a plurality of physical pages, and a confirmation reading control unit that allows to perform concurrent reading of the confirmation reading target pages of the plurality of logical blocks by parallel access control with respect to the first to nth non-volatile memories, when the confirmation reading target pages are read respectively from the logical blocks.

### CROSS REFERENCES TO RELATED APPLICATIONS

The present application claims priority to Japanese Priority Patent Application JP 2011-071420 filed in the Japan Patent Office on Mar. 29, 2011, the entire content of which is hereby incorporated by reference.

### BACKGROUND

The present disclosure relates to a control device, a storage device, and a reading control method. Especially, the present disclosure relates to a storage device which is capable of concurrently accessing a plurality of non-volatile memories and a controlling technique of the storage device.

A storage device using a non-volatile memory such as a NAND type flash memory has been widespread. A non-volatile memory is used, for example, in a memory card, a solid state drive (SSD), an embedded multimedia card (eMMC), and the like which are used in various electronic devices and information processing devices.

Japanese Unexamined Patent Application Publication No. 2009-70098, Japanese Unexamined Patent Application Publication No. 2007-334852, Japanese Unexamined Patent Application Publication No. 2007-193838, and Japanese Unexamined Patent Application Publication No. 2007-58840 disclose a storage device using a flash memory.

In a non-volatile memory, a physical address is used as an address of a physical storage region. With this, a physical block, a physical page, and a physical sector are set. A physical page is composed of a plurality of physical sectors and a physical block is composed of a plurality of physical pages.

Erasing is performed in a physical block unit, and writing (programming) and reading can be performed in a physical page unit.

In address designation from a host side and a memory control unit side, a logical address is used. A logical block, a logical page, and a logical sector indicated by a logical address are associated with the above-described physical address. Accordingly, a logical address is converted into a physical address in an access request and actual access to a flash memory is carried out.

Here, in start-up and the like, the host side performs processing of confirming a storage state of each logical block of a non-volatile memory. That is, the host side confirms whether each logical block is unused, and when each logical block is used for data storage, the host side confirms what data is written.

Therefore, the host side performs an operation of reading a page in which administration information (meta data) is stored from each logical block.

### SUMMARY

However, when such confirmation reading is performed, a certain logical page is read from all logical blocks, so that confirmation reading processing takes time and it takes time to start up, for example, degrading performance of the memory. When there are 4,096 logical blocks, for example, reading has to be repeated 4,096 times.

It is desirable to make such processing of confirmation reading more efficient.

A control device according to an embodiment of the present disclosure includes an administration unit that administrates logical pages of respective logical blocks so that confirmation reading target pages, which are reading targets for storage state confirmation in the respective logical blocks, are arranged in a manner to be dispersed in physical pages of first to nth non-volatile memories among a plurality of logical blocks, in a case where logical blocks including physical blocks of the first to nth non-volatile memories are formed, with respect to a storage device in which concurrent reading access can be performed to the first to nth non-volatile memories serving as non-volatile memories in which a physical block is composed of a plurality of physical pages, and a confirmation reading control unit that allows to perform concurrent reading of the confirmation reading target pages of the plurality of logical blocks by parallel access control with respect to the first to nth non-volatile memories, when the confirmation reading target pages are read respectively from the logical blocks.

A storage device according to another embodiment of the present disclosure includes first to nth non-volatile memories in which a physical block is composed of a plurality of physical pages, an administration unit that administrates logical pages of respective logical blocks so that confirmation reading target pages, which are reading targets for storage state confirmation in the respective logical blocks, are arranged in a manner to be dispersed in physical pages of first to nth non-volatile memories among a plurality of logical blocks, in a case where logical blocks including physical blocks of the first to nth non-volatile memories are formed, and a confirmation reading control unit that allows to perform concurrent reading of the confirmation reading target pages of the plurality of logical blocks by parallel access control with respect to the first to nth non-volatile memories, when the confirmation reading target pages are read respectively from the logical blocks.

A reading control method, according to still another embodiment of the present disclosure, is a reading control method with respect to a storage device in which concurrent reading access can be performed to first to nth non-volatile memories serving as non-volatile memories in which a physical block is composed of a plurality of physical pages. In the reading control method, logical pages of respective logical blocks are administered so that confirmation reading target pages, which are reading targets for storage state confirmation in the respective logical blocks, are arranged in a manner to be dispersed in physical pages of the first to nth non-volatile memories among a plurality of logical blocks, in a case where logical blocks including physical blocks of the first to nth non-volatile memories are formed, and concurrent reading of the confirmation reading target pages of the plurality of logical blocks is allowed to be performed by parallel access control with respect to the first to nth non-volatile memories, when the confirmation reading target pages are read respectively from the logical blocks.

In the technique of the embodiments of the present disclosure, logical pages (confirmation reading target pages) which are read from respective logical blocks in confirmation reading are dispersively arranged in physical pages of the first to nth non-volatile memories in the storage device in which concurrent reading access can be performed in the first to nth non-volatile memories.

Accordingly, reading of the confirmation reading target pages from a plurality of logical blocks can be concurrently performed by parallel concurrent access to the first to nth non-volatile memories.

According to the embodiments of the present disclosure, reading of the confirmation reading target pages from a plurality of logical blocks can be concurrently performed by parallel concurrent access to the first to nth non-volatile memories. Accordingly, reading of the confirmation reading target pages from all of the logical blocks can be made more efficient and processing of confirmation reading which is performed in start-up and cache update can be speeded up.

Additional features and advantages are described herein, and will be apparent from the following Detailed Description and the figures.

### BRIEF DESCRIPTION OF THE FIGURES

FIG. 1 is a block diagram illustrating a memory card according to embodiments of the present disclosure;

FIGS. 2A to 2C illustrate arrangements of physical blocks, logical blocks, and logical pages in a plurality of non-volatile memories;

FIG. 3 illustrates an example of a logical page arrangement in each logical block;

FIG. 4 illustrates a logical page arrangement according to an embodiment;

FIG. 5 illustrates another logical page arrangement according to the embodiment;

FIG. 6 illustrates a logical page arrangement of a case of two channels according to the embodiment;

FIG. 7 illustrates a logical page arrangement of a case of eight channels according to the embodiment;

FIG. 8 illustrates a logical page arrangement according to another embodiment;

FIG. 9 illustrates a function block for confirmation reading processing of the embodiments; and

FIG. 10 is a flowchart of the confirmation reading processing of the embodiments.

### DETAILED DESCRIPTION

Embodiments of the present disclosure are described below in the following order. Here, a memory card 1 in the embodiments is an embodiment of a storage device in the present disclosure. A central processing unit (CPU) 11 in the memory card 1 is an embodiment of a control device in the present disclosure and confirmation reading processing performed by the CPU 11 is an embodiment of a reading control method of the present disclosure.

### <1. Memory Card Configuration>

### <2. Embodiment>

### <3. Another Embodiment>

### <4. Confirmation Reading Processing>

### <5. Modification>

### 1. Memory Card Configuration

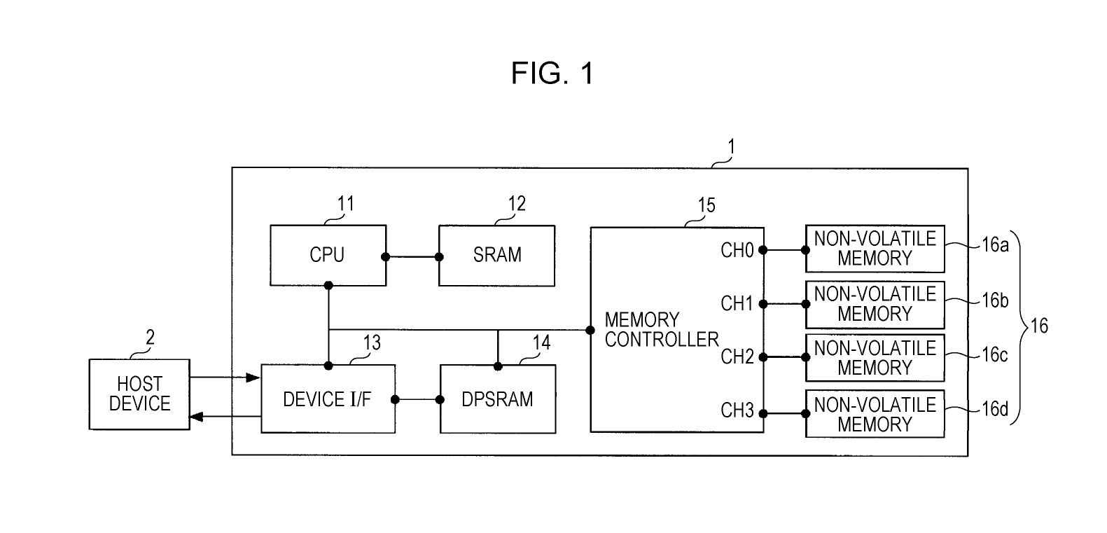

FIG. 1 illustrates the configuration example of the memory card 1 of the embodiments.

The memory card 1 is connected with a host device 2 and is used as a storage device. The host device 2 may be a various electronic devices or information processing devices such as a personal computer, a digital still camera, a video camera, an audio player, a video player, a game instrument, a portable telephone, and an information terminal such as a personal digital assistant (PDA).

The memory card 1 includes the CPU 11, a static random access memory (SRAM) 12, a device interface 13, a dual port SRAM (DPSRAM) 14, a memory controller 15, and four non-volatile memories 16 (16a to 16d).

The CPU 11 controls the whole of the memory card 1. Therefore, the CPU 11 sequentially executes command codes stored in the SRAM 12. The SRAM 12 is used as a region for storage of a program (firmware) executed by the CPU 11 and a work region.

The device interface 13 communicates with the host device 2.

The DPSRAM 14 is used for buffering of transfer data (writing data and reading data) from and to the host device 2.

The memory controller 15 performs writing/reading access with respect to the respective non-volatile memories 16a to 16d based on an instruction of CPU 11.

The CPU 11 controls an operation of data transmission/reception of the device interface 13 with respect to the host device 2, an operation of writing/reading of the DPSRAM 14, and an access operation by the memory controller 15.

As a basic operation of the memory card 1, a writing address, a data size, and data to be written are transmitted along with a writing request from the host device 2 in data writing.

The data to be written which is transmitted from the host device 2 is received at the device interface 13, buffered in the DPSRAM 14, and transferred to the memory controller 15. Then, the memory controller 15 writes the data in the non-volatile memories 16a to 16d in accordance with the control of the CPU 11. The CPU 11 controls these operations in accordance with the writing request, the writing address, and the data size.

In data reading, a reading address and a data size are transmitted along with a reading request from the host device 2. The CPU 11 permits the memory controller 15 to execute reading access based on the reading address and the data size. The memory controller 15 reads instructed data from the non-volatile memories 16a to 16d and buffers the data in the DPSRAM 14. Further, the memory controller 15 performs error correction processing and the like with respect to the buffered reading data. Then, the reading data is transferred from the DPSRAM 14 to the device interface 13 so as to be transmitted to the host device 2.

In the memory card 1 shown in FIG. 1, the memory controller 15 can be connected with the plurality of non-volatile memories 16. To the memory controller 15 of this example, four channels which access the non-volatile memories are provided as channels CH0 to CH3 and the non-volatile memories 16a to 16d are connected to the respective channels CH0 to CH3. The non-volatile memories 16a to 16d are NAND type flash memories, for example.

The memory controller 15 can concurrently execute reading/programming (writing)/erasing with respect to respective channels CH0 to CH3.

That is, the memory controller 15 serves as a memory access unit which can concurrently perform various accesses with respect to the respective non-volatile memories 16a to 16d.

The non-volatile memories 16 have an erasing unit referred to as a physical block and a writing unit referred to as a physical page. Erasing is executed in a physical block unit and writing is executed in a physical page unit.

The CPU 11 forms logical blocks by combining physical blocks with respect to the non-volatile memories 16a to 16d connected with four channels, as a unit for administrating a writing destination of data transmitted via the device interface 13. Further, to the physical page in the logical block, a page number which is called a logical page number is assigned.

Furthermore, the logical page has a logical page data area in which data transmitted from the device interface 13 is written and a meta data area in which administration information (meta data) of the data written in the logical page is stored. Whether data is written in a logical block, and further, in a case where data is written in a logical block, what data is written are recognized by checking meta data of logical page number 0.

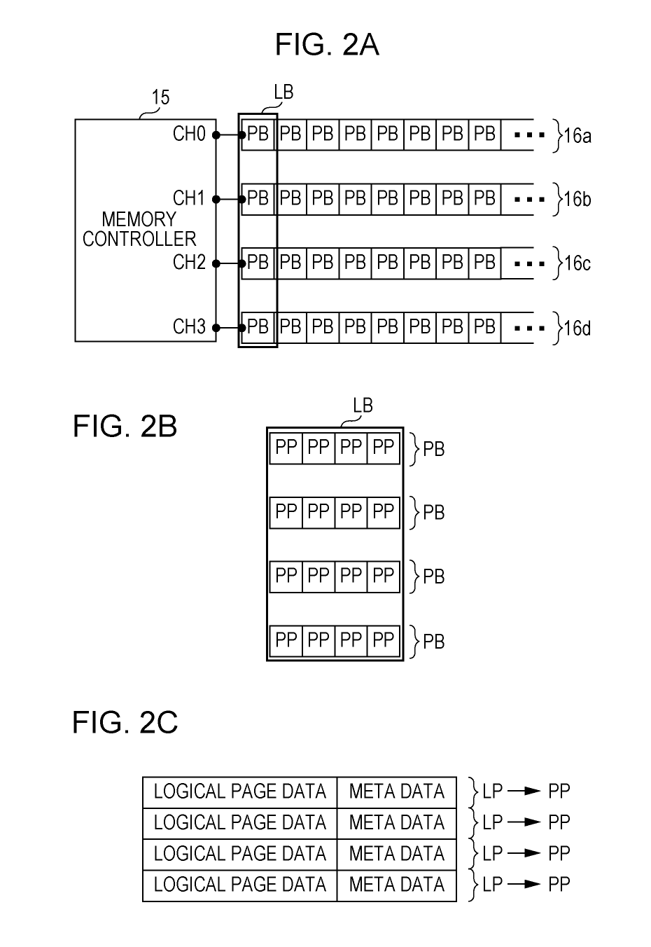

The above-described configuration is described with reference to FIGS. 2A to 2C.

FIG. 2A schematically illustrates physical blocks PB of the non-volatile memories 16a to 16d to which the memory controller 15 accesses by respective channels. A storage region of each of the non-volatile memories 16a to 16d is composed of a large number of physical blocks PB.

Here, the CPU 11 sets a logical block LB so that the logical block LB includes physical blocks PB of the respective non-volatile memories 16a to 16d. FIG. 2A illustrates an example in which a logical block LB is composed of physical blocks PB which are taken one by one from respective non-volatile memories 16a to 16d, as depicted by a thick line. This logical block LB is an administration unit of data to be stored.

FIG. 2B illustrates one logical block LB. If it is assumed that one physical block PB is composed of four physical pages PP, for example, the logical block LB in FIG. 2A includes 16 physical pages PP as illustrated in FIG. 2B.

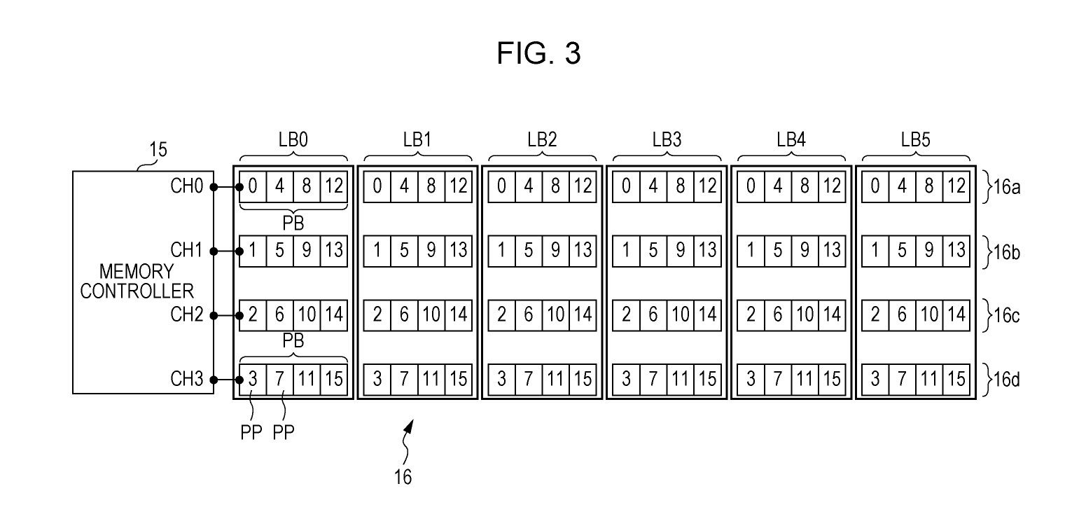

To these physical pages PP, logical page numbers “0” to “15” are respectively assigned. FIG. 3 illustrates an example in which logical page numbers “0” to “15” are assigned to respective physical pages PP in respective logical blocks LB0, LB1, . . . (Numerical numbers in FIG. 3 represent logical page numbers. A logical page of logical page number x is referred below to as a logical page “x”).

In each of the logical blocks LB, data writing is performed by using the logical page from a logical page “0” sequentially.

In one logical page (=physical page), data storage is performed as illustrated in FIG. 2C. That is, a logical page is composed of a logical page data area and a meta data area, and main data such as data transmitted from the host device 2 is stored in the logical page data area. In the meta data area, a meta data (administration information) indicating a using state of a logical block LB and a type of main data which is stored (discrimination between host device data and an internal program, for example) is stored. The meta data is stored when writing of the main data is performed.

In such configuration, when a storage state of a certain logical block LB is confirmed, meta data of a logical page “0” is read out. This is because a logical page is sequentially used from the logical page “0” in a logical block LB as described above.

It is understood that when meta data is not stored in the logical page “0”, the logical block LB is unused.

It is understood that when meta data is stored in the logical page “0”, the logical block LB is used, and what main data is stored can be determined from a content of the meta data.

Here, a typical logical page arrangement example is shown in FIG. 3.

Each of the logical blocks LB0, LB1, LB2, . . . has logical pages “0” to “15”.

As illustrated in FIG. 3, respective logical blocks LB0, LB1, LB2, . . . have the uniform assignment of logical page numbers. Logical pages “0”, “1”, “2”, and “3” are sequentially assigned to the physical pages PP of respective channels CH0 to CH3 and the following logical pages up to a logical page “15” are set in the same fashion.

However, storage state confirmation processing is performed inefficiently in such typical page arrangement.

The host side performs processing of confirming a storage state of each logical block LB of the non-volatile memories 16 in system start-up or cache update, for example.

Therefore, a confirmation reading target page is read from each logical block LB. As described above, a storage state of a logical block LB can be confirmed by reading meta data of a logical page “0”, so that the confirmation reading target page is the logical page “0”.

A case of the page arrangement illustrated in FIG. 3 is considered here.

The logical page “0” is read in each of all of the logical blocks LB0, LB1, LB2, . . . in the confirmation reading processing, and all reading is accessed via the channel CH0.

Accordingly, the CPU 11 instructs the memory controller 15 to sequentially read the logical pages “0” of respective logical blocks LB0, LB1, LB2, . . . . If there are 4,096 logical blocks, for example, reading has to be repeated 4,096 times. Therefore, the confirmation reading takes time, degrading the performance of the memory card 1.

In the embodiments of the present disclosure, a page arrangement is improved so as to more efficiently perform confirmation reading and concurrent access is performed.

### 2. Embodiment

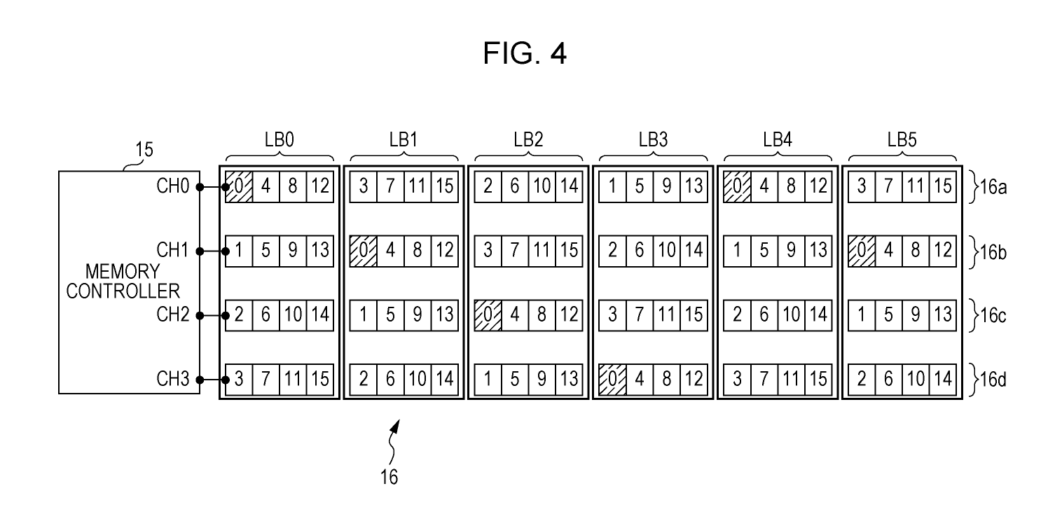

A logical page arrangement of an embodiment is described with reference to FIG. 4. In the embodiment, a logical page “0” is set to be a confirmation reading target page as described above. Logical pages “0” are dispersively arranged in the non-volatile memories 16a to 16d for respective logical blocks of the logical blocks LB0, LB1, . . . which are set for the non-volatile memories 16a to 16d.

As illustrated in FIG. 4, in the logical block LB0, physical pages of the non-volatile memory 16a of the channel CH0 are assigned as logical pages “0”, “4”, 8″, and “12”. Physical pages of the non-volatile memory 16b of the channel CH1 are assigned as logical pages “1”, “5”, “9”, and “13”. Further, physical pages of the non-volatile memory 16c of the channel CH2 are assigned as logical pages “2”, “6”, “10”, and “14”, and physical pages of the non-volatile memory 16d of the channel CH3 are assigned as logical pages “3”, “7”, “11”, and “15”.

That is, in the logical block LB0, the logical pages “0”, “1”, “2”, and “3” are sequentially assigned to physical pages PP of respective channels CH0 to CH3, and logical pages up to the logical page “15” are assigned in the same fashion, as is the case with the respective logical blocks of FIG. 3 described above.

In the next logical block LB1, the above-described assignment is shifted by one channel such that logical pages “3”, “7”, “11”, and “15” are assigned to the channel CH0, logical pages “0”, “4”, “8”, and “12” are assigned to the channel CH1, logical pages “1”, “5”, “9”, and “13” are assigned to the channel CH2, and logical pages “2”, “6”, “10”, and “14” are assigned to the channel CH3.

In this case, due to the assignment shifted by one channel, the head logical page “0” is arranged on a physical page of the channel CHL

The logical blocks LB2 and LB3 respectively have assignments which are shifted by one channel as illustrated in FIG. 4. As a result, the head logical page “0” is arranged on a physical page of the channel CH2 in the logical block LB2, and the head logical page “0” is arranged on a physical page of the channel CH3 in the logical block LB3.

The logical block LB4 has the same arrangement as that of the logical block LB0. Logical blocks on and after the logical block LB5 have similar arrangements. That is, the arrangement patterns of the logical blocks LB0 to LB3 are similarly repeated also on and after the logical block LB4.

Thus, the logical blocks LB have the different page arrangements from each other with regularity.

On analysis, focusing on the logical page “0” (shaded part) which is a confirmation reading target, logical pages of respective logical blocks are administrated such that logical pages “0” are dispersively arranged in physical pages (channels CH0 to CH3) of the non-volatile memories 16a to 16d among in a plurality of logical blocks LB (among logical blocks LB0 to LB3, for example).

Thus, the CPU 11 administrates logical pages of respective logical blocks LB as described above, being able to efficiently execute and control confirmation reading processing.

That is, the respective channels CH0 to CH3 can simultaneously perform reading, so that the CPU 11 can instruct the memory controller 15 to perform concurrent reading access of the respective logical pages “0” of the logical blocks LB0, LB1, LB2, and LB3 and thus make the memory controller 15 read out. In particular, the CPU 11 instructs the memory controller 15 to concurrently read the logical pages “0” from the logical blocks LB0 to LB3 for the respective channels CH0 to CH3. Accordingly, meta data reading of the four logical blocks LB can be concurrently performed.

The CPU 11 instructs concurrent reading of logical pages “0” of the following logical blocks LB4, LB5, LB6, and LB7 in the same fashion.

By such operation, reading of the logical pages “0” from all logical blocks LB can be efficiently performed and therefore, the processing time can be reduced. In a case where there are 4,096 logical blocks LB, for example, reading of the 4,096 logical blocks LB can be completed in time corresponding temporally to reading access of 1,024 times.

That is, when the number of logical blocks of the non-volatile memory is set to be N and the number of channels of the memory controller is set to be M, meta data of all logical blocks can be read in time corresponding to N/M reading times.

Commonly, processing of confirming a using state of all or part of logical blocks and, when the all or part of logical blocks are used, processing of confirming what data is written are performed when the system is started up and cache data stored in the SRAM 12 of FIG. 1 is updated, in the memory card 1.

Accordingly, performing of page administration as illustrated in FIG. 4 can realize reduction of system start-up time and speeding up of update processing of cache data which is produced in writing and reading of data from the host device 2. Consequently, enhancement of writing and reading speed of data from the host device 2 can be expected.

Here, administration of the logical page arrangement as illustrated in FIG. 4 may be performed such that the CPU 11 (and the SRAM 12) stores table data of four patterns for logical blocks LB. For example, the CPU 11 may store table data containing logical page arrangements of respective logical blocks LB0 to LB3.

Since page arrangements have regularity, page arrangement can be administered without especially using table data. For example, a remainder of calculation in which a value of a block address is divided by 4 can be obtained as a channel of a logical page “0” which is a head page. A remainder of a calculation of dividing logical blocks LB0, LB4, LB8, . . . (block address=0, 4, 8, . . . ) by 4 is “0”. In such case, it can be recognized that the logical page “0” is arranged on a head physical page of the channel CH0. In a similar manner, a remainder of a calculation of dividing logical blocks LB1, LB5, LB9, . . . (block address=1, 5, 9, . . . ) by 4 is “1”. Accordingly, it can be recognized that the logical page “0” is arranged on a head physical page of the channel CH1.

This is merely an example. If arrangement is such that logical pages “0” are dispersively arranged and the arrangement has regularity among logical blocks LB, the CPU 11 can obtain a logical page arrangement of each of the logical blocks LB by calculation according to the regularity. In this case, necessity to store a page arrangement table of each block can be eliminated.

Logical pages “0” to “15” are sequentially used for data writing commonly from a small page number. However, in the example of FIG. 4, the logical pages “0”, “1”, “2”, and “3” are respectively sorted to the channels CH0 to CH3, and the logical pages “4”, to “7”, “8” to “11”, and “12” to “15” are sorted in a similar manner.

Sorting of logical pages, which are arranged in order, respectively to the channels CH0 to CH3 enables concurrent writing and reading for four continuous logical pages, contributing enhancement of efficiency of a common operation of data writing/reading.

Here, there are various examples of an arrangement in which logical pages “0” are dispersed to respective channels other than the example of FIG. 4.

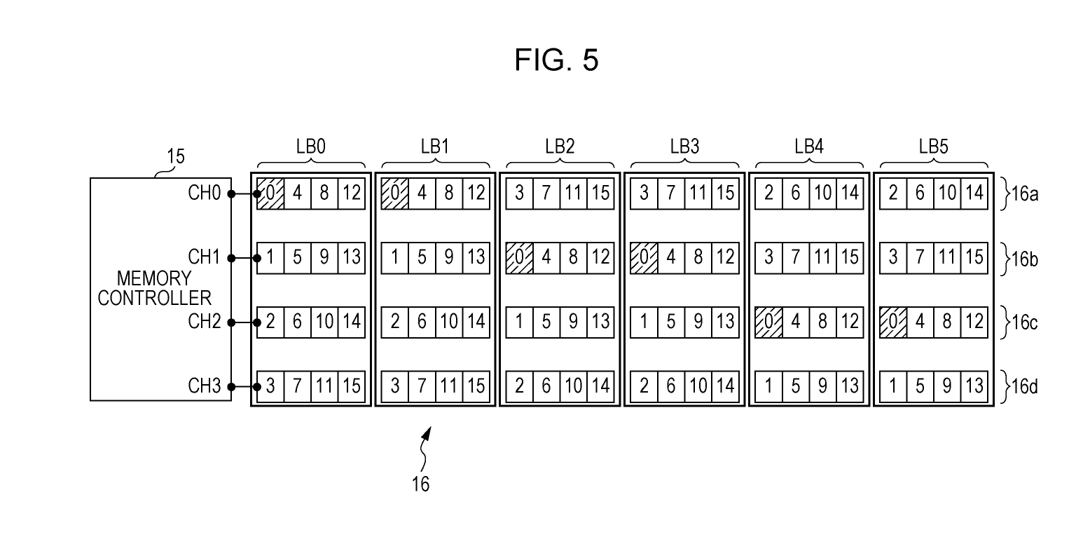

For example, an arrangement may be the one illustrated in FIG. 5. In the case of FIG. 5, the logical blocks LB0 and LB1 have the uniform page arrangement each other, and the logical page “0” is assigned on a head physical page on the channel CH0. The logical blocks LB2 and LB3 have the uniform page arrangement each other, and the logical page “0” is assigned on a head physical page on the channel CH1. The logical blocks LB4 and LB5 have the uniform page arrangement each other, and the logical page “0” is assigned on a head physical page on the channel CH2.

That is, this is an arrangement example in which the logical page arrangement is shifted by every combination of two logical blocks LB.

Of course, it is apparent that further various page arrangement patterns can be employed other than the example of FIG. 5.

Further, an arrangement pattern in which logical pages “0” are dispersed for channels irregularly or in a random manner can be assumed.

However, in any arrangement pattern, it is preferable that approximately same number of logical pages “0” of the logical blocks are arranged in each of the non-volatile memories 16a to 16d. In a case where the total number of logical pages is 4,096, for example, it is set that there are 1,024 logical blocks LB in which logical pages “0” are arranged in the non-volatile memory 16a (channel CH0) and there are 1,024 logical blocks LB in which logical pages “0” are arranged in each of other non-volatile memories 16b, 16c, and 16d (channels CH1, CH2 and CH3).

This is because the best reading efficiency is provided when logical pages “0” of which the number is ¼ of the number of all logical blocks are assigned to physical pages of each channel in the case of the four-channel configuration.

The case of the four-channel configuration has been described so far, but the idea of the embodiment is applicable to a case of other number of channels.

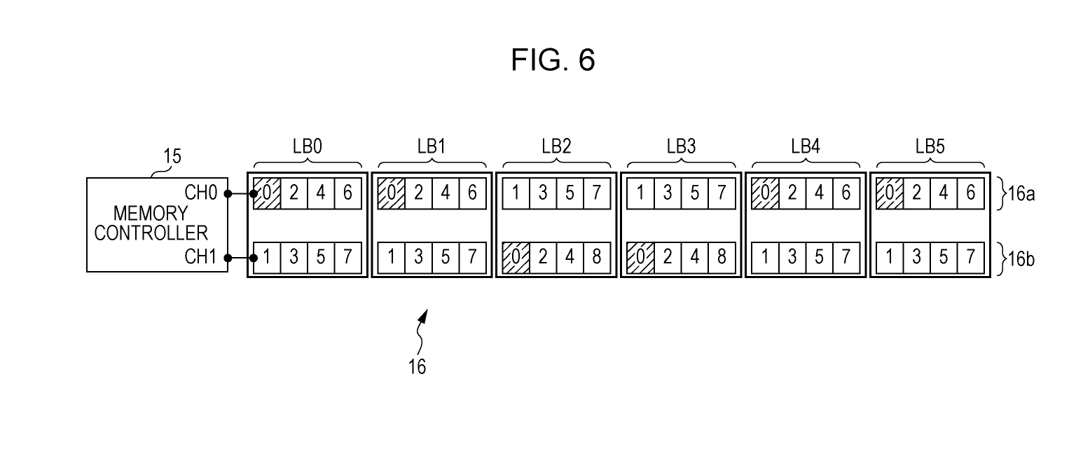

FIG. 6 illustrates a case where the memory controller 15 has two channels and the non-volatile memories 16a and 16b are connected to the channels. In this case, each of the logical blocks LB0, LB1, . . . is composed of eight pages of logical pages “0” to “7” as illustrated in FIG. 6. This logical page arrangement is regularly changed.

That is, logical pages “0”, “2”, “4”, and “6” are assigned to the channel CH0 side and logical pages “1”, “3”, “5”, and “7” are assigned to the channel CH1 side in the logical blocks LB0 and LB1. On the other hand, logical pages “0”, “2”, “4”, and “6” are assigned to the channel CH1 side and logical pages “1”, “3”, “5”, and “7” are assigned to the channel CH0 side in the logical blocks LB2 and LB3. In the following blocks, such page arrangement change is repeated.

Since the channels CH0 and CH1 can be simultaneously accessed, reading of the logical pages “0” from all of the logical blocks LB can be completed in such arrangement in time which is half time of that of a case where reading access is performed with respect to all of the logical blocks in order one by one.

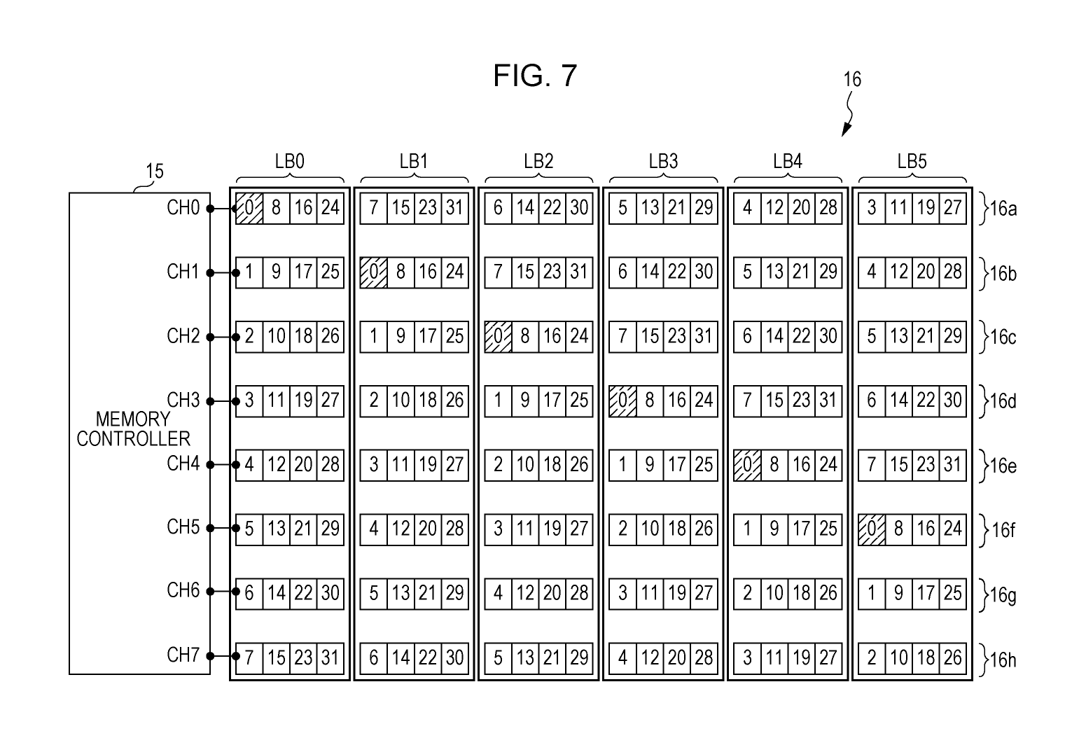

FIG. 7 illustrates a case where the memory controller 15 has eight channels and non-volatile memories 16a to 16h are connected to the channels. In this case, each of the logical blocks LB0, LB1, . . . is composed of 32 pages of logical pages “0” to “31” as illustrated in FIG. 7.

This logical page arrangement is regularly changed as illustrated in FIG. 7.

That is, logical pages “0”, “8”, “16”, and “24” are assigned to the channel CH0 in the logical block LB0. In the next block LB1, logical pages “0”, “8”, “16”, and “24” are assigned to the channel CH1. After that, a channel to which the head logical page “0” is assigned is shifted in order in the logical blocks. Though it is not illustrated, the logical block LB8 has the same page arrangement as that of the logical block LB0, and the following arrangements are also shifted in every logical block in the same fashion.

Since the channels CH0 and CH7 can be simultaneously accessed, reading of the logical pages “0” from all of the logical blocks LB can be completed in such arrangement in time which is ⅛ times as long as time of that of a case where reading access is performed with respect to all of the logical blocks in order one by one.

The examples of two channels and eight channels have described above, but other arrangement patterns such as an irregular pattern and a random pattern can be assumed.

Further, in a case of other number of channels, enhancement of efficiency of confirmation reading can be realized by dispersively arranging the logical pages “0” for respective channels in the same fashion.

Further, in cases of any number of channels, it is preferable that approximately same number of logical block confirmation reading target pages (logical pages “0”) are arranged in each of the first to nth non-volatile memories which are respectively connected to the n pieces of channels. This is because if same number of logical block confirmation reading target pages are arranged for respective channels, reading time of meta data of all of the logical blocks can be completed in time which is 1/n times as long as time of a case where reading access is performed with respect to all of the logical blocks in order one by one and the best efficiency is provided.

Of course, there is a case where the number of logical pages “0” is not same for all channels due to the relationship of the number of logical blocks and the number of channels (a case where the number of logical blocks is indivisible by the number of channels). In such case, it is most efficient and preferable that the number of logical pages “0” is set to be almost same for all channels as much as possible, that is, the difference in the numbers of the logical pages “0” which are arranged for respective channels is set to be equal to or less than 1.

### 3. Another Embodiment

Another embodiment is described. In the above-described embodiment, head logical pages (logical pages “0”) of respective logical blocks are confirmation reading target pages and are dispersively arranged on different channels (different physical blocks) among a plurality of logical blocks. The reason why a logical page “0” is set to be a confirmation reading target page in the above-described embodiment is that meta data is inevitably written in the logical page “0” in the initial data writing.

Here, there is a case where a system operation is determined such that meta data of a plurality of logical pages is inevitably stored in the initial data writing. This is a case where a plurality of confirmation reading target pages may exist in a logical block.

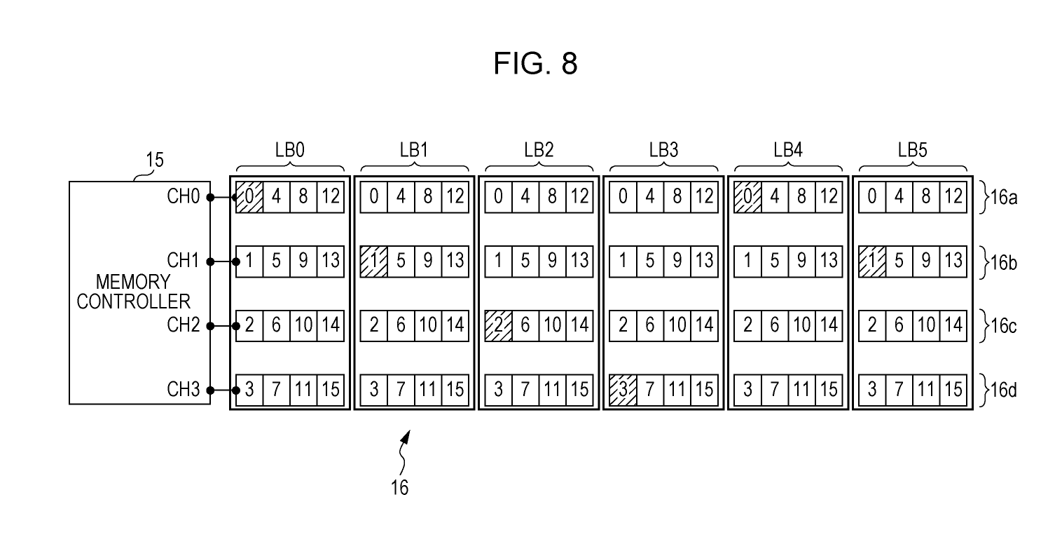

For example, it is set that when writing is performed with respect to the logical block LB, data is inevitably written in head physical pages of physical blocks which constitute the logical block LB and are connected to respective channels. For example, it is set that data is inevitably written respectively in logical pages “0”, “1”, “2”, and “3” in each logical block LB in the initial writing, in a case of the four-channel configuration illustrated in FIG. 8.

Further, it is set that the meta data of all of the logical pages “0”, “1”, “2”, and “3” has information indicating how the corresponding logical block LB is used.

In a case where such system operation is performed, any of the four logical pages “0”, “1”, “2”, and “3” can be used as a confirmation reading target page in each logical block LB.

In this case, more efficient confirmation reading processing can be realized in administration of a logical page arrangement depicted in FIG. 8, as is the case with the embodiment described first.

In FIG. 8, an arrangement state of logical pages with respect to respective physical pages is uniform in all of the logical blocks LB0, LB1, LB2, . . . . In all of the logical blocks LB, the logical pages “0”, “1”, “2”, and “3” are respectively sorted to the channels CH0 to CH3.

In this case, the CPU 11 can efficiently execution-control the confirmation reading processing as the following.

Since the respective channels CH0 to CH3 can simultaneously perform reading, the CPU 11 selects confirmation reading target pages which are used in confirmation reading so that channels are dispersed for the logical blocks LB0, LB1, LB2, and LB3.

That is, as depicted by slanting lines in FIG. 8, the logical page “0” is selected as the confirmation reading target page in the logical block LB0, and the logical page “1” is selected as the confirmation reading target page in the logical block LB1, for example. Further, the logical page “2” is selected as the confirmation reading target page in the logical block LB2, and the logical page “3” is selected as the confirmation reading target page in the logical block LB3.

The CPU 11 instructs the memory controller 15 to perform concurrent reading access of these selected confirmation reading target pages so as to make the memory controller 15 perform reading. Accordingly, meta data reading of four logical blocks LB can be concurrently performed.

The CPU 11 instructs concurrent reading of the logical pages “0”, “1”, “2”, and “3” in each of the following logical blocks LB4, LB5, LB6, and LB7 in the same fashion.

With such operation, reading of meta data indicating a storage state from all of the logical blocks LB can be efficiently performed and processing time can be reduced.

In the other embodiment, a plurality of confirmation reading target pages are arranged in physical pages of the non-volatile memories 16a to 16d in one logical block LB as described above, so that the CPU 11 makes such state that confirmation reading target pages which are selected one by one from the respective logical blocks LB are dispersed in the physical pages of the non-volatile memories 16a to 16d (channels CH0 to CH3) among the plurality of logical blocks. This enables concurrent meta data reading of four logical blocks.

Here, a plurality of confirmation reading target pages of each of the logical blocks LB are set to be the logical pages “0”, “1”, “2”, and “3” corresponding to four head physical pages in the above description, but the confirmation reading target pages are not limited to these pages. It is sufficient that a plurality of logical pages are set to be confirmation reading target pages as logical pages to which meta data is first stored, in principle.

The plurality of confirmation reading target pages described above in each of the logical blocks LB are set as four logical pages from the head logical page “0” in the logical block, but this is not limited as well. It is sufficient that a plurality of logical pages are set to be confirmation reading target pages as logical pages in which meta data is first stored, in principle.

Further, in the example of FIG. 8, logical pages in the respective logical blocks LB are respectively administrated in physical pages of the respective logical blocks in the same arrangement state. In this case, the CPU 11 does not have to discriminate logical page arrangements among the respective logical blocks LB and does not have to administrate the logical page arrangement for each of the logical blocks. Accordingly, load of administration processing and load on an area such as an administration table are reduced.

However, even though a plurality of confirmation reading target pages can be set, it is possible to set different logical page arrangements in the plurality of logical blocks LB, as the case of the embodiment described first.

It is apparent that the idea of the embodiment described second is applicable to the configuration of other number of channels (equal to or more than two channels) other than the four channel configuration.

### 4. Confirmation Reading Processing

The confirmation reading processing of the CPU 11 in the above-described embodiments is described.

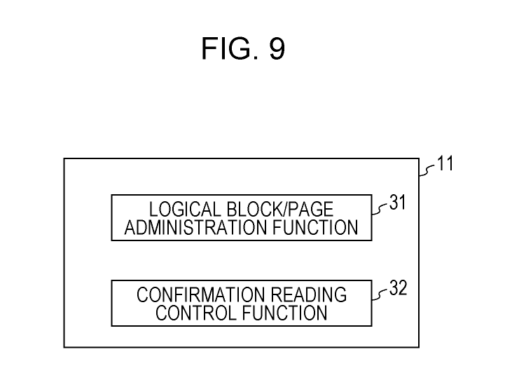

Depending on the CPU 11 (and the SRAM 12), a logical block/page administration function 31 and a confirmation reading control function 32 are provided by software as functions to realize the confirmation reading processing of the above-described embodiments, as illustrated in FIG. 9.

Here, these function parts are provided as software functions which are developed as processing of the CPU 11, but these parts may be formed by hardware.

The logical block/page administration function 31 here is a function to administrate logical pages of each logical block so that confirmation reading target pages which are reading targets for storage state confirmation in each logical block are dispersed in physical pages of the first to nth non-volatile memories among a plurality of logical blocks in a case where logical blocks are formed in a manner to include physical blocks of respective first to nth non-volatile memories which can be concurrently read out. The logical block/page administration function 31 corresponds to an administration unit according to the embodiment of the present disclosure.

In a case where logical page arrangements are different from each other among a plurality of logical blocks LB as the embodiment described first, the logical block/page administration function 31 uses a page arrangement table corresponding to each of the logical blocks LB, or in a case where page arrangements have regularity, the logical block/page administration function 31 sets such that a page arrangement of each of the logical blocks LB can be recognized by calculation. In a case where the logical blocks LB have the same page arrangement each other as the embodiment described second, it is sufficient that the logical block/page administration function 31 can merely recognize the page arrangement in the logical block.

The confirmation reading control function 32 is a control function to allow (instruct the memory controller 15) to concurrently read confirmation reading target pages of a plurality of logical blocks by concurrent access control with respect to the first to nth non-volatile memories when a confirmation reading target page is read out from each of the logical blocks. The confirmation reading control function 32 corresponds to a confirmation reading control unit according to the embodiment of the present disclosure.

In the case of the embodiment described first, the confirmation reading control function 32 instructs the memory controller 15 to concurrently read the logical pages “0” from the plurality of logical blocks LB.

In the case of the embodiment described second, the confirmation reading control function 32 instructs the memory controller 15 to select confirmation reading target pages used for respective logical blocks LB and concurrently read these pages from the plurality of logical blocks LB.

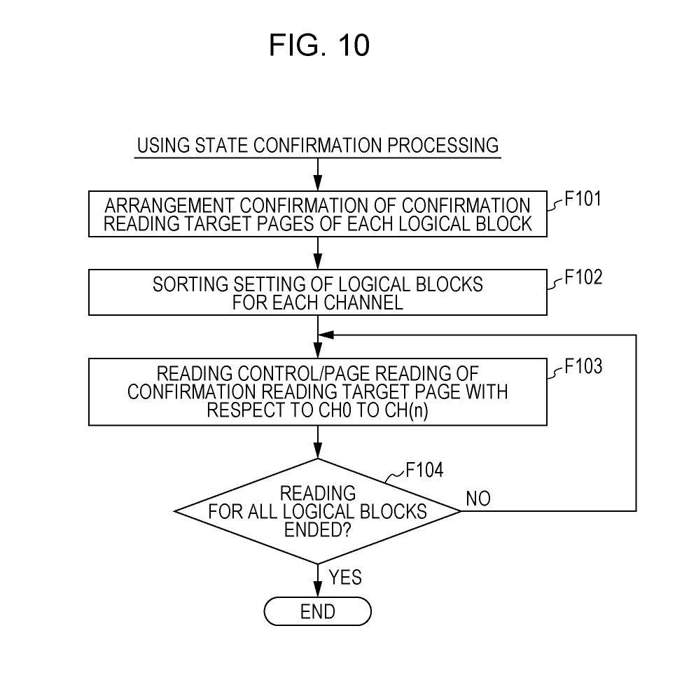

FIG. 10 illustrates a control operation of the CPU 11 (the confirmation reading control function 32) as the confirmation reading processing.

When, the confirmation reading processing is performed, the CPU 11 first confirms an arrangement of confirmation reading target pages of respective logical blocks LB in step F101. The logical block/page administration function 31 in the CPU 11 grasps the arrangement of the confirmation reading target pages.

Subsequently, the CPU 11 sorts the logical blocks for respective channels.

Then, the CPU 11 instructs the memory controller 15 to concurrently read the confirmation reading target pages by using a plurality of channels CH0 to CH(n) so as to allow the memory controller 15 to read necessary meta data in step F103. This processing is repeated until the reading of the confirmation reading target pages from all logical blocks is completed in step F104. When the reading from all logical blocks is completed, the confirmation reading processing is ended.

The above-described processing of FIG. 10 is described based on the example of FIG. 4 of the embodiment described first. The CPU 11 confirms an arrangement of the logical pages “0” in step F101 so as to grasp an administration state that the logical pages “0” are dispersed to the channels CH0, CH1, CH2, and CH3 in the logical blocks LB0, LB1, LB2, and LB3. Then, the CPU 11 performs sorting of the logical blocks LB based on the administration state in step F102. That is, the logical blocks LB0, LB4, LB8, . . . are assigned to the channel CH0. The logical blocks LB1, LB5, LB9, . . . are assigned to the channel CH1. The logical blocks LB2, LB6, LB10, . . . are assigned to the channel CH2, and the logical blocks LB3, LB7, LB11, . . . are assigned to the channel CH3.

After the logical blocks LB are assigned to each of the channels CH0 to CH3 as this, the CPU 11 instructs concurrent reading of the logical pages “0” for assigned logical blocks in step F103. First, the CPU 11 instructs concurrent reading by the channel CH0 to CH3 for the logical blocks LB0 to LB3. Then, the CPU 11 instructs concurrent reading by the channel CH0 to CH3 for the logical blocks LB4 to LB7 in step F103. This is repeated up to the last logical block.

The processing of FIG. 10 is described based on the example of FIG. 8 of the embodiment described second. The CPU 11 confirms an administration state that the logical pages “0” to “3” are arranged on respective head physical pages in step F101. Then, the CPU 11 performs sorting of the logical blocks LB while selecting the confirmation reading target pages used for respective logical blocks LB based on the administration state in step F102.

For example, the logical pages “0” are used for the logical blocks LB0, LB4, LB8, . . . , and these pages are assigned to the channel CH0. The logical pages “1” are used for the logical blocks LB1, LB5, LB9, . . . , and these pages are assigned to the channel CH1. Further, the logical pages “2” are used for the logical blocks LB2, LB6, LB10, . . . , and these pages are assigned to the channel CH2, and the logical pages “3” are used for the logical blocks LB3, LB7, LB11, . . . , and these pages are assigned to the channel CH3.

After the logical blocks LB are assigned to the respective channels CH0 to CH3, the CPU 11 instructs concurrent reading of the selected logical pages for assigned logical blocks in step F103. First, the CPU 11 instructs concurrent reading of the logical pages “0”, “1”, “2”, and “3” by the channels CH0 to CH3 for the logical blocks LB0 to LB3. Then, the CPU 11 instructs concurrent reading of the logical pages “0”, “1”, “2”, and “3” by the channels CH0 to CH3 for the logical blocks LB4 to LB7. This is repeated up to the last logical block.

By the control processing of the CPU 11 described above, more efficient confirmation reading processing is realized.

### 5. Modification

The embodiments have been described so far, but various modifications can be considered. It has been described that there are various variations of the number of channels of the memory controller 15 and the page arrangement in the logical blocks, but there are other various examples.

If the configuration including a plurality of physical blocks is employed as the logical block configuration, the technique of the present disclosure is applicable even though physical blocks of all channels are not necessarily included. For example, in a case where the system of the memory card 1 has the six-channel configuration of channels CH0 to CH5, the logical block configurations of FIGS. 4 and 8 can be set for the four channels of the non-volatile memories 16a to 16d. That is, if confirmation reading target pages are dispersively arranged among a plurality of logical blocks, in a plurality of non-volatile memories which can be simultaneously read, the technique of the present disclosure is applicable.

The example of the memory card 1 is described in the embodiments, but the technique of the present disclosure is applicable also in a case where the non-volatile memories 16 and the CPU 11 (and the SRAM 12) are separately provided. For example, the technique of the present disclosure can be realized as a control device for controlling reading with respect to a plurality of non-volatile memories.

The technique of the present disclosure is applicable to various memory cards, SSDs, eMMCs.

The technique of the present disclosure can have the following configurations.

(1) A control device including

an administration unit that administrates logical pages of respective logical blocks so that confirmation reading target pages, which are reading targets for storage state confirmation in the respective logical blocks, are arranged in a manner to be dispersed in physical pages of first to nth non-volatile memories among a plurality of logical blocks, in a case where logical blocks including physical blocks of the first to nth non-volatile memories are formed, with respect to a storage device in which concurrent reading access can be performed to the first to nth non-volatile memories serving as non-volatile memories in which a physical block is composed of a plurality of physical pages, and

a confirmation reading control unit that allows to perform concurrent reading of the confirmation reading target pages of the plurality of logical blocks by parallel access control with respect to the first to nth non-volatile memories, when the confirmation reading target pages are read respectively from the logical blocks.

(2) The control device according to the above (1), in which the confirmation reading target pages are logical pages to which administration data is inevitably written in initial writing with respect to the logical blocks.

(3) The control device according to the above (1) or (2), in which the confirmation reading target pages are head logical pages in the logical blocks.

(4) The control device according to one of the above (1) to (3), in which the administration unit administrates such that the logical pages of the respective logical blocks are arranged in physical pages in the respective logical blocks in different ways among the respective logical blocks with regularity.

(5) The control device according to the above (1) or (2), in which the administration unit makes such state that a plurality of the confirmation reading target pages are arranged in physical pages of the first to nth non-volatile memories in one logical block so as to disperse confirmation reading target pages that are selected one by one from the respective logical blocks in the physical pages of the first to nth non-volatile memories among the plurality of logical blocks.

(6) The control device according to the above (5), in which the plurality of confirmation reading target pages are a plurality of logical pages that correspond to head physical pages in the respective physical blocks of the first to nth non-volatile memories and constitute the logical blocks.

(7) The control device according to the above (5) or (6), in which the plurality of confirmation reading target pages are predetermined number of logical pages from a head logical page in a logical block.

(8) The control device according to any one of the above (5) to (7), in which the administration unit administrates to arrange the logical pages of the respective logical blocks on physical pages in the respective logical blocks in a uniform arrangement state.

(9) The control device according to any one of the above (1) to (8), in which the administration unit administrates the logical pages of the respective logical blocks so that approximately same number of the confirmation reading target pages of the logical blocks are arranged on each of the first to nth non-volatile memories.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A control device, comprising:
an administration unit that administrates logical pages of respective logical blocks so that confirmation reading target pages, the confirmation reading target pages being reading targets for storage state confirmation in the respective logical blocks, are arranged in a manner to be dispersed in physical pages of first to nth non-volatile memories among a plurality of logical blocks, in a case where logical blocks including physical blocks of the first to nth non-volatile memories are formed, with respect to a storage device in which concurrent reading access can be performed to the first to nth non-volatile memories serving as non-volatile memories in which a physical block is composed of a plurality of physical pages; and
a confirmation reading control unit that allows to perform concurrent reading of the confirmation reading target pages of the plurality of logical blocks by parallel access control with respect to the first to nth non-volatile memories, when the confirmation reading target pages are read respectively from the logical blocks.

2. The control device according to claim 1, wherein the confirmation reading target pages are logical pages to which administration data is inevitably written in initial writing with respect to the logical blocks.

3. The control device according to claim 2, wherein the confirmation reading target pages are head logical pages in the logical blocks.

4. The control device according to claim 3, wherein the administration unit administrates such that the logical pages of the respective logical blocks are arranged in physical pages in the respective logical blocks in different ways among the respective logical blocks with regularity.

5. The control device according to claim 1, wherein the administration unit makes such state that a plurality of the confirmation reading target pages are arranged in physical pages of the first to nth non-volatile memories in one logical block so as to disperse confirmation reading target pages that are selected one by one from the respective logical blocks in the physical pages of the first to nth non-volatile memories among the plurality of logical blocks.

6. The control device according to claim 5, wherein the plurality of confirmation reading target pages are a plurality of logical pages that correspond to head physical pages in the respective physical blocks of the first to nth non-volatile memories and constitute the logical blocks.

7. The control device according to claim 5, wherein the plurality of confirmation reading target pages are predetermined number of logical pages from a head logical page in a logical block.

8. The control device according to claim 5, wherein the administration unit administrates to arrange the logical pages of the respective logical blocks on physical pages in the respective logical blocks in a uniform arrangement state.

9. The control device according to claim 1, wherein the administration unit administrates the logical pages of the respective logical blocks so that approximately same number of the confirmation reading target pages of the logical blocks are arranged on each of the first to nth non-volatile memories.

10. A storage device, comprising:
first to nth non-volatile memories in which a physical block is composed of a plurality of physical pages;
an administration unit that administrates logical pages of respective logical blocks so that confirmation reading target pages, the confirmation reading target pages being reading targets for storage state confirmation in the respective logical blocks, are arranged in a manner to be dispersed in physical pages of first to nth non-volatile memories among a plurality of logical blocks, in a case where logical blocks including physical blocks of the first to nth non-volatile memories are formed; and
a confirmation reading control unit that allows to perform concurrent reading of the confirmation reading target pages of the plurality of logical blocks by parallel access control with respect to the first to nth non-volatile memories, when the confirmation reading target pages are read respectively from the logical blocks.

11. The storage device according to claim 10, further comprising:
a memory access unit that includes first to nth channels to which the first to nth non-volatile memories respectively connected and is capable of concurrent reading access with respect to the first to nth non-volatile memories by access concurrently using the plurality of channels; wherein
the confirmation reading control unit allows the memory access unit to concurrently perform access to the confirmation reading target pages of the plurality of logical blocks by using the first to nth channels when the confirmation reading target pages are read from the respective logical blocks.

12. A reading control method with respect to a storage device in which concurrent reading access can be performed to first to nth non-volatile memories serving as non-volatile memories in which a physical block is composed of a plurality of physical pages, the method comprising:
administrating logical pages of respective logical blocks so that confirmation reading target pages, the confirmation reading target pages being reading targets for storage state confirmation in the respective logical blocks, are arranged in a manner to be dispersed in physical pages of the first to nth non-volatile memories among a plurality of logical blocks, in a case where logical blocks including physical blocks of the first to nth non-volatile memories are formed; and
allowing to perform concurrent reading of the confirmation reading target pages of the plurality of logical blocks by parallel access control with respect to the first to nth non-volatile memories, when the confirmation reading target pages are read respectively from the logical blocks.
